(19) United States
(12) Patent Application Publication
(10) Pub. No.: US 2013/0305486 A1
(43) Pub. Date: Nov. 21, 2013

(54) PUSH HANDLE FOR A TRANSPORT CART

(71) Applicants: Horst Sonnendorfer, Puchheim (DE); Franz Wieth, Puchheim (DE)

(72) Inventors: Horst Sonnendorfer, Puchheim (DE); Franz Wieth, Puchheim (DE)

(21) Appl. No.: 13/877,245

(22) PCT Filed: Sep. 30, 2011
(86) PCT No.: PCT/EP2011/067149

§ 371 Date: Jul. 17, 2013

(30) Foreign Application Priority Data
Sep. 30, 2010 (DE) 20 2010 013 748.9
Dec. 2, 2010 (DE) 10 2010 053 032.8

(51) Int. Cl. B62B 5/06

(52) U.S. Cl. CPC B62B 5/06
USPC 16/111.1; 16/430

(57) ABSTRACT

A push handle for a transport cart that is movable by hand has a fastening element for fastening the push handle to a handle support arm of the transport cart. The fastening element defines an at least substantially transversely extending fastening axis for a grip part. The longitudinal axis of the grip part is arranged substantially perpendicular to the fastening shaft. The grip part is rotatably mounted about the fastening axis, and the grip part is fixable in at least one position.

The invention relates to a push handle for a transport cart movable by hand, comprising a fastening element for fastening the push handle to a handle support arm of the transport cart, the fastening element forming an at least substantially transversely extending fastening axis for a grip part, and the longitudinal axis of the grip part being arranged at least substantially perpendicular to the fastening axis.

Transport carts movable by hand are used in particular as what are known as shopping carts in wholesale trade and in retail trade. Depending on the purpose, they have different shapes and sizes. Transport carts for small to medium-sized retail trade goods are generally basket-shaped and have two handle support arms protruding at one end, between which a transversely extending handlebar is fastened. A shopping cart that is only lightly loaded can be pushed easily by hand through the aisles of a shop, centrally at the handlebar. If the shopping cart is full, the handlebar is grasped by both hands. This allows a better transfer of force and, above all, a controlled change of direction of the then heavy shopping cart by pushing and pulling on the handlebar in opposite directions. The disadvantage of such handlebars is that the hands always have to be turned laterally, against their natural position, in order to grasp the transversely extending handle.

Transport carts for heavy and bulky goods, as can be found for example in a DIY store or wholesale store, generally have a planar, laterally open loading surface and handle support arms rising vertically on the outside of the transport cart with perpendicularly oriented grips fastened to the upper end of said handle support arms. Such upwardly protruding grips, ideally angled toward the user, accommodate a person's natural hand position and allow him to move even heavily loaded transport carts. When grasping these grips, the skeleton of the arm assumes a position in which the force of the upper arm muscles can be converted efficiently into a pushing or pulling movement of the hands. A transport cart of this type is presented in DE 10 2006 043 522 A1.

Shopping carts are also known, which utilize the advantages of both handle forms. They connect two perpendicularly arranged handle portions inclined toward the user to a transversely extending tubular push handle. A transport cart of this type is known for example from DE 10 2006 034 048 A1.

These constructions are limited in many respects. On the one hand, it must always be ensured that the position of the push handle and of the push bar does not prevent the shopping carts from being fitted together and therefore always has to be arranged above or to the side of the next shopping cart in the line. The height of the perpendicular grips and of the handlebar has to be designed such that a user of average size can comfortably grasp both the perpendicular grip and the transversely extending handlebar. In addition, the perpendicular grip should be sufficiently long so that it can be grasped by the entire hand. Only then is an ergonomic pushing position possible. A perpendicularly oriented grip thus always defines the highest point of the handle construction.

For transport to their place of use, the shopping carts fitted together in lines are stacked one on another in layers. Ergonomically designed, upwardly oriented handle portions then protrude considerably above the level of the fitted together shopping carts. In order to stack a plurality of layers of fitted together shopping carts in a space-saving manner, the perpendicular grip parts therefore cannot be of arbitrary height. This provision makes it impossible to produce upwardly protruding grips of ergonomically sufficient length.

The object of the invention is to propose a push handle for transport carts, of which the grip, described hereinafter as a grip part, is ergonomically designed, without having to waste space during transport of the shopping carts.

This object is achieved by a push handle having the features in claim 1. A fundamental basic concept of the invention lies in the fact that the grip part of the push handle is mounted rotatably about the fastening axis, and in that the grip part can be fixed in at least one position. The grip part designed in accordance with the invention can thus assume different positions in its pivot plane about the fastening axis. Due to the rotatable mounting, the grip part can be formed in a length necessary for grasping by the entire hand, without having to waste space during the supply of the transport carts.

Pivoted into its transport position, the grip part assumes a horizontal or even downwardly directed position. Pivoted in this way, the grip part according to the invention protrudes at least no longer significantly beyond the level of the handle support arm. The free end of the grip part in the transport position preferably points in the direction of the shopping cart, whereby the total length of the shopping cart and therefore the spatial requirement is further reduced. To erect the grip part, it is pivoted about the fastening axis and then assumes a pushing position, in which it protrudes significantly beyond the level of the handle support arm. The pivotable grip part can consequently be arranged on the shopping cart in a region in which it can be easily grasped at any time by the person pushing the shopping cart.

This erected position of the grip part, referred to as the pushing position, is normally set after the supply of the transport carts. Two grip parts are then generally provided on shopping carts equipped with grips, and the pushing position of said two grip parts should be matched to one another. It is therefore advantageous if the pushing position of the grip parts is predetermined as a defined position. Then, the correct orientation of the two grip parts relative to one another does not also have to be taken into consideration when the two grip parts are pivoted.

A matched position of the two grip parts to one another can be provided in a particularly simple manner by latching the grip parts in place when the desired position is reached. The two grip parts of the shopping cart are always oriented in the same angle once pivoted into the predefined latched position. In a particularly advantageous embodiment, the grip parts are fixed permanently once the pushing position is reached, such that the person pivoting the grip part into the pushing position does not have to carry out any further assembly steps.

If the fastening axis is oriented transversely, the longitudinal axis of the handle extension extends in a preferred embodiment inclined in an angle between 70 and 98 degrees with respect to the fastening axis. Such an inclination of the grip parts is found to be particularly comfortable by the user of the shopping cart.

In the natural rest position of the arms, the palms are inclined slightly toward the longitudinal axis of the body. Here, the region of the palms adjoining the thumbs is located closer to the longitudinal axis than the region adjoining the small fingers. This natural position of the hands corresponds to the situation when the grip parts deviate to a certain extent from the vertical, since the ends remote from the fastening axis are inclined toward one another. Of course, the grip parts do not have to be straight, but can assume a curved progression along their longitudinal axis for further ergonomic optimization.

It is particularly advantageous if the grip parts have a recess for the thumbs. Grip parts designed in this way can be grasped particularly comfortably. When fixing the pushing position, it should be ensured that it is most comfortable for the person grasping the grip part when the grip part is inclined slightly away from him.

The ergonomic shaping and positioning is only noticeable with uniform pushing of the shopping cart when the triceps muscle is used primarily, or with pulling of the shopping cart by means of the biceps muscle. In particular when navigating corners or more considerably when maneuvering about the vertical axis of the transport cart, the user grasping the grip parts pushes with one arm and pulls with the other arm. Accordingly, the biceps muscle is tensed in one arm and the triceps muscle is tensed in the other arm.

The grip parts designed in accordance with the invention thus facilitates the maneuvering of heavy transport carts, in particular for weaker individuals. The advantageous effect of the position according to the invention of the grip parts is all the more noticeable, the weaker the pushing person and the heavier the transport cart.

In a further preferred embodiment, the fastening axis of the grip part extends inclined in an angle between 10 and 30 degrees with respect to the horizontal, the grip part being offset outwardly in its downwardly pivoted position. The grip part is pivotable along an oblique plane so to speak in this embodiment. The end of the grip part remote from the fastening axis can thus be pivoted from a laterally outwardly offset transport position into a pushing position arranged between the handle support arms of the shopping cart. The downwardly directed, laterally outwardly offset transport position leaves the insertion opening on the shopping cart free, this being necessary in order to fit together the shopping carts.

By contrast, a grip part fastened to a horizontal fastening axis protrudes into the insertion opening of the shopping cart if pivoted below the level of the handle support arms. It would therefore not be possible to fit the shopping carts closely together. In order to prevent this, it is advantageous with a horizontally oriented fastening axis to prevent the grip part from pivoting into the region of the insertion opening by delimiting the angle of rotation.

The fastening element preferably has a substantially horizontally extending handle profile at its end remote from the handle support arm. The user of the shopping cart can then select between different grips and can find the one most comfortable for him. In a particularly ergonomically designed embodiment, the level of the handle profile descends toward the handle support arm, following the natural hand position. In addition, the shape of the handle profile can be adapted under consideration of the further ergonomic viewpoints already presented.

It is also advantageous if the fastening element has an enlarged region, which can be used as a support surface for the palms when pushing the transport cart or when waiting at the till. An enlarged region of this type can additionally easily be designed as a receptacle for a deposit lock and/or a key fastening.

In a particularly preferred embodiment, the two push handles held on the handle support arms of a shopping cart are interconnected via a connection element arranged therebetween. The push handle unit thus formed forms a transverse strut, which additionally stabilizes the shopping cart. Here, the connection element can be designed as a simple handlebar.

A particular advantage is provided as a result of the fact that the transverse strut is assembled on and also fastened to the same fastening elements as the grip parts. Fewer process steps are thus necessary in order to assemble the push handle unit.

The space additionally available as a result of the connection element can also be used however in order to form a holder for a coin cassette and/or a key fastening and/or a scanner holder. The connection element advantageously has an information area inclined toward the user of the push handle unit and designed in particular as an electronic display, via which information of interest to the user, for example current advertising or data concerning goods recorded by the scanner, can be presented to the user.

In the region of the push bar and/or the grip part and/or the fastening element, electrically conductive elements are advantageously provided, which are connected to the metal parts of the transport cart. This provides the advantage that the metal parts of the shopping cart, which basically behave as a capacitor, can be earthed. The earthing is achieved via the conductive elements to the metal parts of the transport cart by means of the user stood on the ground. As a result, the charge produced when pushing the transport cart cannot be stored in the metal parts.

The invention will be explained in greater detail on the basis of possible exemplary embodiments, but without limiting the invention to these exemplary embodiments.

In the drawings, specifically:

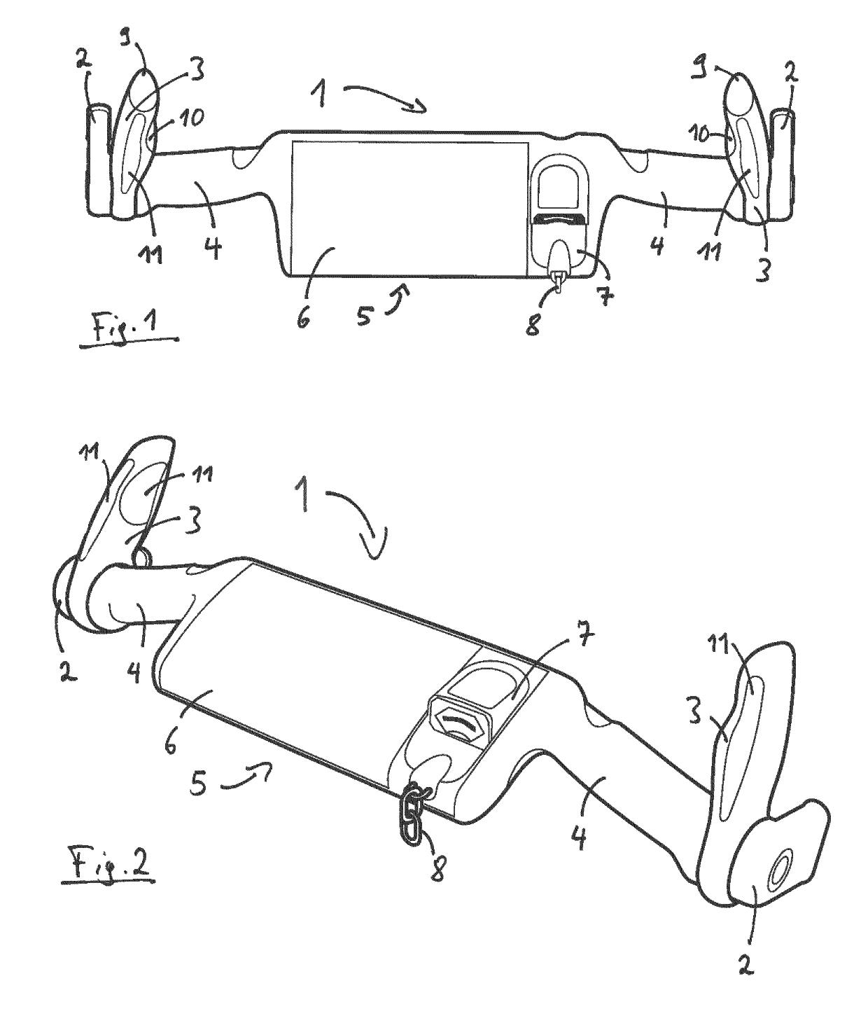

FIG. 1: shows a schematic view from the direction of the user of an embodiment of a push handle device according to the invention with grip parts located in the pushing position,

FIG. 2: shows a perspective illustration of the push handle device according to FIG. 1,

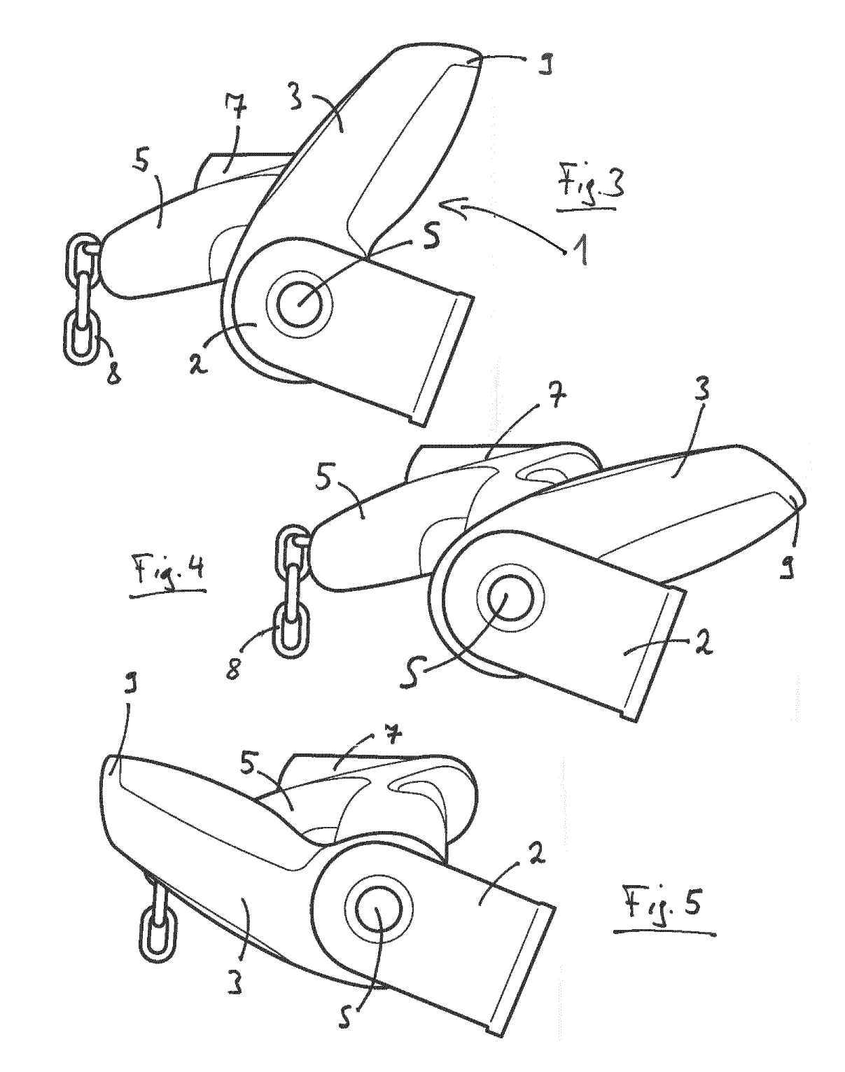

FIG. 3: shows a side view of the push handle device shown in FIGS. 1,

FIGS. 4 and 5: shows further side views of the push handle device shown in FIG. 1 with the grip parts in two possible transport positions,

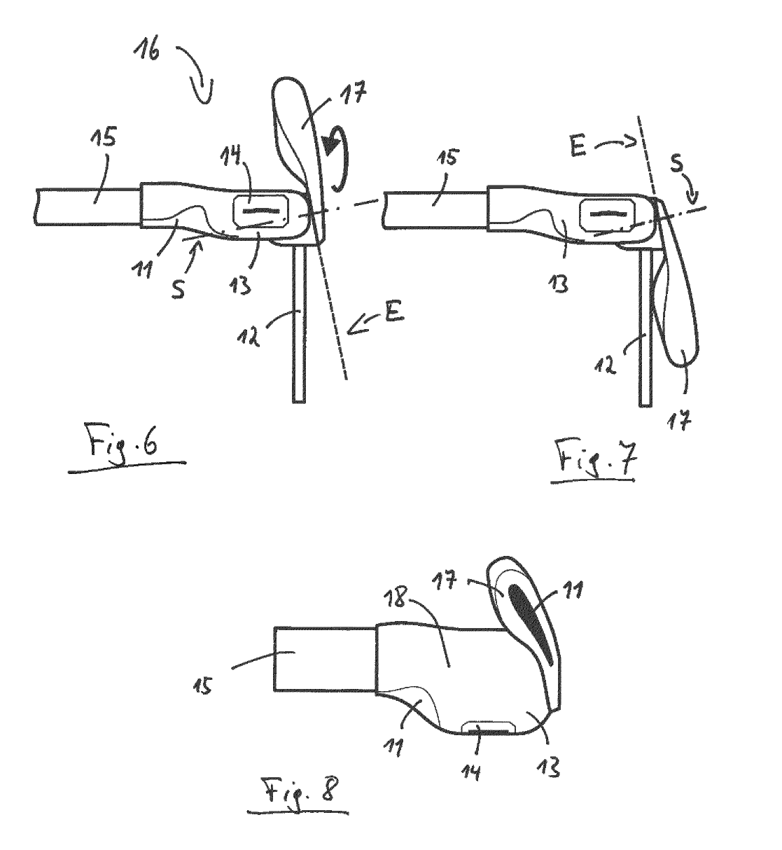

FIG. 6: shows an exemplary embodiment of a push handle with an inclined fastening axis, in which the grip part is arranged in the pushing position,

FIG. 7: shows the push handle according to FIG. 6 with the grip part in the transport position, and

FIG. 8: shows a plan view of the push handle according to FIG. 6.

The embodiment shown in FIG. 1 comprises outer fastening elements 2 terminating the push handle device 1 and via which the push handle device 1 is fastened to handle support arms (not shown here). The fastening elements 2 comprise an inwardly directed tubular portion extending at least substantially transversely, on which they support the pivotable grip parts 3. Handle profiles 4 oriented substantially transversely on the whole adjoin the inner face of the fastening elements 2 and transition into a connection element 5. Within the meaning of this application, transversely means parallel to the plane that is defined by the points of contact between the rollers of the transport cart and the ground.

The connection element 5 is designed in a planar manner and has a display 6 as well as a laterally offset deposit lock 7 with chain portion 8 fastened thereto. Of course, other embodiments can also be provided, for example with a display 6 fully covering the connection element. The deposit lock 7 and the chain portion 8 carrying the key (not shown) may also be arranged on the fastening element 2.

The grip parts 3 are curved inwardly slightly along their longitudinal axis for ergonomic reasons, so that their ends 9 pointing away from the push handle unit 1 are inclined toward one another. Recesses 10 for the thumbs additionally facilitate the grasping of the grip parts 3. Electrically conductive portions 11, via which the built-up charge can be dissipated, are inlaid into the grip parts 3.

In the perspective illustration according to FIG. 2 it can be clearly seen that the fastening elements 2 are formed externally as handle caps, which are fitted onto a handle support arm (not shown) of a shopping cart, where they can be fastened in a known manner. The fastening element 2 forms a fastening axis S extending at least substantially transversely. The respective pivotable grip part 3, the adjoining substantially transversely oriented handle profile 4, and the connection element 5 are fastened to this fastening element 2 on the fastening axis S. The fastening axis S intersects the handle support arm. It is thus possible to fasten the fastening element 2 to the handle support arm together with the other parts of the push handle device via a common fastening means, in particular a screw. All parts of the push handle device can be fastened in this manner in a single process step to the handle support arm. The simple fastening process is, of course, also disclosed for the other embodiments according to the invention of the push handle device and the push handle.

The two grip parts 3 are located in a pushing position, in which they are each inclined away from the user of the shopping cart by approximately 20 degrees. The handle profiles 4 oriented transversely on the whole are arranged slightly upwardly with respect to the connection element 5, so that the adjoining planar connection element 5 assumes an elevated position toward the user. The deposit lock 7 is partly integrated into the connection element 5.

In terms of production, it is advantageous if the connection element 5 and the adjoining handle profiles 4 are formed in one piece. A standardized plastic part of this type can be produced easily. If the fastening elements 2 are manufactured with different widths of their portion extending transversely on the whole, the push handle unit 1 can be adapted to the spacing between the handle support arms of a shopping cart type by means of the selection of the matching fastening element 2.

FIG. 3 shows a side view of the push handle arrangement 1, wherein the grip part 3 to the front in the viewing direction covers the rear grip part 3 of identical orientation. In this illustration it can be clearly seen that the cap of the fastening element 2 can be oriented in accordance with the predetermined angle of the handle support arm on the shopping cart. An adjustment of the rest of the component parts of the push handle device 1 is not necessary.

Due to the handle profiles 4 likewise arranged here in a covered manner, the connection element 5 is arranged above the fastening axis S oriented in this illustration perpendicularly to the side view. The partly integrated deposit lock 7 protruding toward the user from the connection element 5 and a plurality of links of the chain portion 8 can be seen in part.

FIGS. 4 and 5 show alternative transport positions of the grip part 3, which cannot be pivoted downwardly via its end 9 due to its horizontal fastening axis S, since, in this position, it would block the insertion opening for fitting together the shopping carts in a line. In FIG. 4, the grip part is inclined toward the shopping cart and, in this case, is arranged so flat that it does not significantly increase the level of the push handle device 1. The same is true for the transport position shown in FIG. 5, inclined away from the shopping cart.

In FIG. 6, a handle support arm 12 of a shopping cart is illustrated. The fastening element 13 shown here is fastened to the handle support arm 12 in one of the conventional manners.

The fastening element 13 is formed with a large area and has a region on the upper face for placement of the hands. A deposit lock 14 is integrated into the fastening element 13.

The push bar 15 is connected to the fastening element 13. In the shown example, only part of the push rod 15 is shown. With the push handle 16 according to the invention, the push rod 15 reaches as far as the opposite side. There, the push rod 15 is connected to a further fastening element 13. This fastening element 13 (not illustrated here) does not comprise a deposit lock however, although it is conceivable to integrate another functional element into the side part there.

The grip part 17 is mounted rotatably on the fastening element 13 about a fastening axis S, which extends at an incline to the plane that extends through the points of contact of the rollers of the transport cart. The grip part 17 can thus be pivoted along an inclined plane E from an upper, ergonomically inwardly inclined pushing position into a lower, outwardly directed transport position, in which the shopping carts are not hindered from being pushed one inside the other.

Conductive regions 11, which are connected to the metal parts of the transport cart, are located in the fastening element 13, in the push handle 15, and in the grip part 17. The earthing described further above of the transport cart takes place via these regions 11.

Further electrically conductive regions are optionally provided at other regions not visible in the figure.

FIG. 7 shows the elements known from FIG. 6, with the difference that the grip part 17 is now pivoted downwardly along the plane E.

Depending on the embodiment, it is possible to design the grip parts 17 so as to be pivotable about a defined angle or so as to make a variable angle settable.

In the case of the variably settable pivot angle, it is possible for the customer to set the angle suitable for his requirements. For example, a lock can be released by means of a button for adjusting the grip part 17, or the grip part 17 itself can be rotated about its longitudinal axis, and an eccentric can thus be loosened and fixed again.

FIG. 8 shows an overall view of the push handle 16 with the support faces 18 for the hands designed in a rounded manner and with a larger area compared to the push bar 15.

The support faces 18 are designed in a descending manner in the direction of the handle support arm in relation to the level of the push bar 15 in order to ergonomically optimize the support faces 18.

1-20. (canceled)

21. A push handle assembly for a manually movable transport cart, comprising:
a fastening element for fastening a push handle to a handle support arm of the transport cart, said fastening element forming a substantially transverse fastening axis;
a grip part having a longitudinal axis extending substantially perpendicularly to said fastening axis; and
said grip part being rotatably mounted about said fastening axis and fixable in at least one position of said grip part.

22. The push handle according to claim 21, wherein said longitudinal axis of said grip part is inclined with an angle between 70 and 98 degrees with respect to said fastening axis.

23. The push handle according to claim 21, wherein said fastening axis extends inclined at an angle between 10 and 30 degrees with respect to the horizontal.

24. The push handle according to claim 21, wherein said fastening element has a substantially transversely extending handle profile at an end thereof remote from the handle support arm, and wherein a level of the handle profile descends toward the handle support arm.

25. The push handle according to claim 21, wherein at least one of said grip part or said handle profile is formed with electrically conductive plastic and wherein said electrically conductive plastic and including an electrical connection to conductive parts of the transport cart.

26. The push handle according to claim 21, wherein said fastening element comprises a receptacle or a holder for a deposit lock and/or a key fastening.

27. A push handle assembly for a transport cart, comprising two push handles according to claim 21 and a connection element connecting said two push handles to one another and being disposed between said push handles.

28. The push handle assembly according to claim 27, wherein said connection element includes one or more elements selected from the group consisting of a holder for a deposit lock, a key fastening element, and a scanner holder.

29. The push handle assembly according to claim 28, wherein said connection element comprises an information surface area.

30. The push handle assembly according to claim 29, wherein said information surface area contains an electronic information area, inclined toward a user of the push handle assembly.
